(19) United States
(12) Patent Application Publication
(10) Pub. No.: US 2010/0038599 A1
(43) Pub. Date: Feb. 18, 2010

(54) POLYMERIZABLE SEMICONDUCTORS, POLYMERS THEREOF, AND METHODS OF MAKING AND USING SAME

(76) Inventor: Bradley J. Holliday, Austin, TX (US)

Correspondence Address: Ballard Spahr LLP, SUITE 1000, 999 PEACHTREE STREET, ATLANTA, GA, 30309-3915, US

(21) Appl. No.: 12/541,478

(22) Filed: Aug. 14, 2009

Related U.S. Application Data
(60) Provisional application No. 61/089,505, filed on Aug. 16, 2008.

(51) Int. Cl. H01B 1/12

(52) U.S. Cl. 252/500

(57) ABSTRACT

Disclosed are compounds comprising at least one semiconductor and/or photon absorber; and a polymerizable residue covalently bound thereto. In a further aspect, a disclosed polymer can be a polymer of a disclosed compound. In one aspect, a disclosed polymer can comprise at least one semiconductor and/or photon absorber covalently bound to one or more side-chains thereof. In a further aspect, a disclosed device can comprise a disclosed compound and/or a disclosed polymer made therefrom and/or a disclosed polymer. A device can, for example, comprise a photovoltaic cell. Also disclosed are methods for making and using the compounds, polymers, and devices.

### CROSS REFERENCE TO RELATED APPLICATIONS

This application claims priority to U.S. Provisional Patent Application Ser. No. 61/089,505, filed Aug. 16, 2008, which is hereby incorporated by reference.

### BACKGROUND

Recent research has focused on optical-electronic devices. Typical optical-electronic devices can perform a number of functions. For example, an optical-electronic device can absorb one or more photons and convert the resulting energy into electricity. An example of such a device is a photovoltaic device. If a photovoltaic device absorbs light from the sun, it can be referred to as a solar cell. An optical-electronic device can also absorb one or more photons and emit the resulting energy as light in the form of fluorescence or phosphorescence. Similarly, a current can be applied to an optical-electronic device thereby inducing fluorescence and/or phosphorescence from a material therein. An example of such a device is a light emitting diode device (LED).

Various configurations of optical electronic devices are known in the art. A photovoltaic device, for example, can comprise an anode, a cathode, and one or more semiconducting layers therebetween, including, for example, an n-type layer, a p-type layer, and/or an intrinsic or i-layer. An LED can comprise, for example, an anode, a cathode, with an electron transport material, a hole transport material, and an emissive material positioned therebetween. The electron transport material, hole transport material, and/or emissive material can be present in one more layers.

At least one challenge in the field of optical-electronics relates to device production and processing of the materials therein. Oftentimes, a functional small molecule that is to be incorporated into a device can exhibit properties, such as, for example, crystallinity, that can render device processing difficult. Some crystalline small molecules, for example, need to be vacuum deposited onto a substrate of a device. Other challenges relate to the alignment of the functional materials in the device. Still other challenges develop during the operation of the device, particularly when small molecule components are used.

Thus, a need exists for new materials and methods that overcome challenges in the art, a few of which are mentioned above. These needs and other needs are at least partially satisfied by the present invention.

### SUMMARY

In accordance with the purpose(s) of the invention, as embodied and broadly described herein, the invention, in one aspect, relates to compounds comprising a semiconductor, polymers thereof, devices comprising the compounds and/or polymers thereof, and methods of making the compounds, polymers, and devices.

In one aspect, a disclosed compound comprises at least one semiconductor; and a polymerizable residue covalently bound thereto. In a further aspect, a disclosed polymer can be a polymer of a disclosed compound. In one aspect, a disclosed polymer can comprise at least one semiconductor covalently bound to one or more side-chains thereof. In a further aspect, a disclosed device can comprise a disclosed compound and/or a disclosed polymer made therefrom and/or a disclosed polymer. A device can, for example, comprise a photovoltaic cell. Also disclosed are methods for making and using the compounds, polymers, and devices.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 is an example of a compound comprising a generic semiconductor covalently bound to a polymerizable residue, and the polymer and copolymer thereof.

FIG. 2 is an illustration of the optical band gaps of four exemplary disclosed semiconducting perylene diimides.

FIG. 3 is an illustration of the general relationship between the molecular structure of a disclosed embodiment, the morphology thereof, and the resulting device properties.

FIG. 4 is an illustration of an exemplary photovoltaic device.

FIG. 5 is an illustration of an exemplary photovoltaic device comprising a phase-seperated morphology of a disclosed tri-block copolymer.

FIG. 6 is a plot of absorbance and emission of a disclosed compound (A) and a polymer produced therefrom (B).

FIG. 7 is a plot from a cyclic voltammagram of a disclosed compound and a polymer produced therefrom.

FIG. 8 is a plot of absorbance and emission of a disclosed polymer and the corresponding plot of absorbance and emission of a small residue thereof.

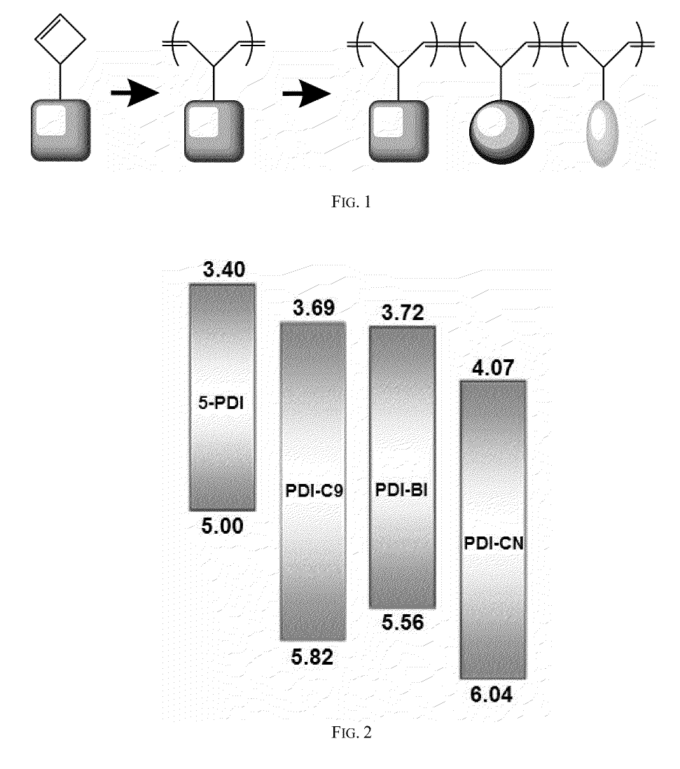

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates.

### A. DEFINITIONS

As used in the specification and the appended claims, the singular forms “a,” “an” and “the” include plural referents unless the context clearly dictates otherwise. Thus, for example, reference to “a residue,” “a polymer,” or “a semiconductor” includes mixtures of two or more such residues, polymers, or semiconductors, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed. In various aspects, if a number of atoms, for example, carbon, are disclosed, such as, for example, 1 to 10, 1 to 12, 1 to 20 or more, the specific recited aspect, along with other aspects including other ranges of atoms less than and greater than the specifically recited number of atoms are also intended to be disclosed. Thus, a disclosure of 1 to 12 atoms should comprise the disclosure of 1 to 12 atoms, along with for example, 1 to 6 atoms, 1 to 15 atoms, 1 to 20 atoms, or more.

As used herein, the terms “optional” or “optionally” mean that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, a norbornene residue in a polynorbornene refers to one or more norbornen units in the polynorbornene, regardless of whether norbornene was used to prepare the polynorbornene. In some aspects, a residue can be only part of a disclosed compound or polymer. For example, the semiconductor portion of a small molecule polymerizable semiconductor can be referred to as a residue. Likewise, the polymerizable portion can be referred to as a residue of the compound.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. The term “optionally substituted,” means that the compound, atom, or residue can or cannot be substituted, as defined herein.

In defining various terms, “A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “alkyl” as used herein is a branched or unbranched saturated hydrocarbon group of 1 to 24 carbon atoms, 1 to 20 carbons, 1 to 18 carbons, 1 to 16 carbons, 1 to 14 carbons, 1 to 10 carbons, 1 to 8 carbons, 1 to 6 carbons, 1 to 4 carbons, 1 to 3 carbons, or 1 to 2 carbons, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dode cyl, tetradecyl, hexadecyl, eicosyl, tetracosyl, and the like. The alkyl group can also be substituted or unsubstituted. The alkyl group can be substituted with one or more groups including, but not limited to, optionally substituted alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, optionally substituted alkyl, cycloalkyl, alkoxy, amino, ether, halide, hydroxy, nitro, silyl, sulfo-oxo, or thiol as described herein.

The terms “alkoxy” and “alkoxyl” as used herein to refer to an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹-OA² or —OA¹-(OA²)ₐ-OA³, where “a” is an integer of from 1 to 200 and A¹, A², and A³ are alkyl and/or cycloalkyl groups.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, optionally substituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, optionally substituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 24 carbon atoms with a structural formula containing at least one carbon-carbon triple bond. The alkynyl group can be unsubstituted or substituted with one or more groups including, but not limited to, optionally substituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The term “heterocycloalkynyl” is a type of cycloalkenyl group as defined above, and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be substituted or unsubstituted. The cycloalkynyl group and heterocycloalkynyl group can be substituted with one or more groups including, but not limited to, optionally substituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, optionally substituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein. The term “biaryl” is a specific type of aryl group and is included in the definition of “aryl.” Biaryl refers to two aryl groups that are bound together via a fused ring structure, as in naphthalene, or are attached via one or more carbon-.carbon bonds, as in biphenyl.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15 carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15 carbon atoms, 2 to 12 carbon atoms, 2 to 8 carbon atoms, 2 to 4 carbon atoms, or 2 to 4 carbon atoms

A very close synonym of the term “residue” is the term “radical,” which as used in the specification and concluding claims, refers to a fragment, group, or substructure of a molecule described herein, regardless of how the molecule is prepared. For example, a 2,4-thiazolidinedione radical in a particular compound has the structure

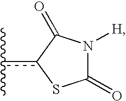

regardless of whether thiazolidinedione is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

“Inorganic radicals,” as the term is defined and used herein, contain no carbon atoms and therefore comprise only atoms other than carbon. Inorganic radicals comprise bonded combinations of atoms selected from hydrogen, nitrogen, oxygen, silicon, phosphorus, sulfur, selenium, and halogens such as fluorine, chlorine, bromine, and iodine, which can be present individually or bonded together in their chemically stable combinations. Inorganic radicals have 10 or fewer, or preferably one to six or one to four inorganic atoms as listed above bonded together. Examples of inorganic radicals include, but not limited to, amino, hydroxy, halogens, nitro, thiol, sulfate, phosphate, and like commonly known inorganic radicals. The inorganic radicals do not have bonded therein the metallic elements of the periodic table (such as the alkali metals, alkaline earth metals, transition metals, lanthanide metals, or actinide metals), although such metal ions can sometimes serve as a pharmaceutically acceptable cation for anionic inorganic radicals such as a sulfate, phosphate, or like anionic inorganic radical. Inorganic radicals do not comprise metalloids elements such as boron, aluminum, gallium, germanium, arsenic, tin, lead, or tellurium, or the noble gas elements, unless otherwise specifically indicated elsewhere herein.

The term “aldehyde” as used herein is represented by the formula —C(O)H. Throughout this specification “C(O)” is a short hand notation for a carbonyl group, i.e., C═O.

The terms “amine” or “amino” as used herein are represented by the formula NA¹A²A³, where A¹, A², and A³ can be, independently, hydrogen or substituted or unsubstituted alkyl, cycloalkyl, alkenyl, cycloalkenyl, alkynyl, cycloalkynyl, aryl, or heteroaryl group as described herein.

The term “carboxylic acid” as used herein is represented by the formula —C(O)OH.

The term “ester” as used herein is represented by the formula —OC(O)A¹ or —C(O)OA¹, where A¹ can be a substituted or unsubstituted alkyl, cycloalkyl, alkenyl, cycloalkenyl, alkynyl, cycloalkynyl, aryl, or heteroaryl group as described herein. The term “polyester” as used herein is represented by the formula -(A¹O(O)C-A²-C(O))ₐ— or -(A¹O(O)C-A²-OC(O))ₐ—, where A¹ and A² can be, independently, a substituted or unsubstituted alkyl, cycloalkyl, alkenyl, cycloalkenyl, alkynyl, cycloalkynyl, aryl, or heteroaryl group described herein and “a” is an integer from 1 to 500. “Polyester” is the term used to describe a group that is produced by the reaction between a compound having at least two carboxylic acid groups with a compound having at least two hydroxyl groups.

The term “ether” as used herein is represented by the formula A¹OA², where A¹ and A² can be, independently, a substituted or unsubstituted alkyl, cycloalkyl, alkenyl, cycloalkenyl, alkynyl, cycloalkynyl, aryl, or heteroaryl group described herein. The term “polyether” as used herein is represented by the formula -(A¹O-A²O)ₐ—, where A¹ and A² can be, independently, a substituted or unsubstituted alkyl, cycloalkyl, alkenyl, cycloalkenyl, alkynyl, cycloalkynyl, aryl, or heteroaryl group described herein and “a” is an integer of from 1 to 500. Examples of polyether groups include polyethylene oxide, polypropylene oxide, and polybutylene oxide.

The terms “halide” and “halo” as used herein refer to the halogens fluorine, chlorine, bromine, and iodine.

The terms “hydroxy” and “hydroxyl” as used herein is represented by the formula —OH.

The term “ketone” and “keto” as used herein is represented by the formula A¹C(O)A², where A¹ and A² can be, independently, a substituted or unsubstituted alkyl, cycloalkyl, alkenyl, cycloalkenyl, alkynyl, cycloalkynyl, aryl, or heteroaryl group as described herein.

The term “azide” as used herein is represented by the formula —N₃.

The term “nitro” as used herein is represented by the formula —NO₂.

The terms “nitrile” and “cyano” as used herein are represented by the formula —CN.

The term “silyl” as used herein is represented by the formula —SiA¹A²A³, where A¹, A² and A³ can be, independently, hydrogen or a substituted or unsubstituted alkyl, cycloalkyl, alkoxy, alkenyl, cycloalkenyl, alkynyl, cycloalkynyl, aryl, or heteroaryl group as described herein.

The term “sulfo-oxo” as used herein is represented by the formulas —S(O)A¹, —S(O)₂A¹, —OS(O)₂A¹, or —OS(O)₂OA¹, where A¹ can be hydrogen or a substituted or unsubstituted alkyl, cycloalkyl, alkenyl, cycloalkenyl, alkynyl, cycloalkynyl, aryl, or heteroaryl group as described herein. Throughout this specification “S(O)” is a short hand notation for S═O. The term “sulfonyl” is used herein to refer to the sulfo-oxo group represented by the formula —S(O)₂A¹, where A¹ can be hydrogen or a substituted or unsubstituted alkyl, cycloalkyl, alkenyl, cycloalkenyl, alkynyl, cycloalkynyl, aryl, or heteroaryl group as described herein. The term “sulfone” as used herein is represented by the formula A¹S(O)₂A², where A¹ and A² can be, independently, a substituted or unsubstituted alkyl, cycloalkyl, alkenyl, cycloalkenyl, alkynyl, cycloalkynyl, aryl, or heteroaryl group as described herein. The term “sulfoxide” as used herein is represented by the formula A¹S(O)A², where A¹ and A² can be, independently, a substituted or unsubstituted alkyl, cycloalkyl, alkenyl, cycloalkenyl, alkynyl, cycloalkynyl, aryl, or heteroaryl group as described herein.

The term “thiol” as used herein is represented by the formula —SH.

Compounds described herein can contain one or more double bonds and, thus, potentially give rise to cis/trans (E/Z) isomers, as well as other conformational isomers. Unless stated to the contrary, the invention includes all such possible isomers, as well as mixtures of such isomers. Likewise, certain disclosed cyclic and bicyclic compounds can have exo or endo isomerism. In this case, both isomers are considered disclosed, unless the context expressly dictates otherwise.

If a disclosed chemical species is said to be “conjugated,” it is meant that the chemical species has at least two alternating π bonds. For example, if a chemical species has alternating π and sigma bonds, that chemical species is conjugated. In one aspect, conjugation refers to at least partial electron (e.g., π electron) delocalization, although conjugation does not guarantee electron delocalization. An example of a conjugated chemical species is an aryl group, as discussed herein.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture. Compounds described herein can contain one or more asymmetric centers and, thus, potentially give rise to diastereomers and optical isomers. Unless stated to the contrary, the present invention includes all such possible diastereomers as well as their racemic mixtures, their substantially pure resolved enantiomers, all possible geometric isomers, and pharmaceutically acceptable salts thereof. Mixtures of stereoisomers, as well as isolated specific stereoisomers, are also included. During the course of the synthetic procedures used to prepare such compounds, or in using racemization or epimerization procedures known to those skilled in the art, the products of such procedures can be a mixture of stereoisomers.

As used herein, the terms “polymerizable moiety” and “polymerizable residue” refer to a chemical functionality capable of undergoing a polymerization reaction or cross-linking reaction to form a higher molecular weight compound and/or a more highly cross-linked structure. Suitable examples include alkenyl groups, methacryloyloxy groups, acryloyloxy groups, methacryl amide groups, acryl amide groups, styryl groups, vinyl groups, vinyl carbonate groups, vinyl carbamate groups, allyl carbonate groups, or allyl carbamate groups.

As used herein, the term “polymer” refers to a macromolecule with one or more repeating units. A polymer can be or can include, for example, an oligomer (a small 5 polymer), a homopolymer, or a copolymer, including an alternating copolymer, a random copolymer, a block copolymer (e.g., a tri-block copolymer, a tri-block terpolymer), a blocky copolymer, or a grafi copolymer. It should be understood that the term “copolymer” as used herein, is intended to refer to a polymeric material derived from two or more monomer species, and can include, without limitation, copolymers, terpolymers, and other higher order polymers.

It is understood that the polymer of a disclosed compound, even if not explicitly disclosed, is considered disclosed. For example, if a compound comprising norbornene is disclosed, the polynorbornene of that compound should be considered disclosed.

In certain instances, a catalytic residue can be present on one or more ends of a polymer, and, while not explicitly disclosed or shown, any catalytic residue originating from a polymerization method can be present. For example, during Ring-Opening Metathesis Polymerization (ROMP) using a Grubbs' catalyst, an alkylidene residue present on the catalyst can react with a monomer, such that at least a portion of the alkylidene residue can be present as an end-group on the resulting polymer. Likewise, any residue of a compound used to terminate a polymerization can be present as an end-group. For example, if ethyl vinyl ether is used to terminate a ROMP, then a residue from the ethyl vinyl ether can be present as an end-group in the resulting polymer.

As used herein, a “living polymerization” is intended to refer to a polymerization wherein chain termination and chain transfer reactions are substantially absent from the polymerization. Generally, at least two criteria exist for determining whether a polymerization is living or not, although both criteria do not always need to be satisfied. First, the number averaged molecular weight will generally be approximately linear versus the monomer-to-initiator (or catalyst) ratio. Second, a block or blocky copolymer can generally be produced from a “living” polymer chain. Examples of living polymerizations include, but are not limited to, ROMP, certain cationic polymerizations, and certain anionic polymerizations, certain free radical polymerizations, and Ziegler-Natta polymerizations.

As used herein, the term “molecular weight” (MW) refers to the mass of one molecule of that substance, relative to the unified atomic mass unit u (equal to 1/12 the mass of one atom of carbon-12).

As used herein, the term “number average molecular weight” (Mₙ) refers to the common, mean, average of the molecular weights of the individual polymers. Mₙ can be determined by measuring the molecular weight of n polymer molecules, summing the weights, and dividing by n. Mₙ is calculated by:

$${\overline{M}}_{n} = \frac{{\sum }_{i} {N}_{i} {M}_{i}}{{\sum }_{i} {N}_{i}} ,$$

wherein Nᵢ is the number of molecules of molecular weight Mᵢ. The number average molecular weight of a polymer can be determined by gel permeation chromatography, viscometry (Mark-Houwink equation), light scattering, analytical ultracentrifugation, vapor pressure osmometry, end-group titration, and colligative properties.

As used herein, the term “weight average molecular weight” (M_{w}) refers to an alternative measure of the molecular weight of a polymer. M_{w} is calculated by:

$${\overline{M}}_{ω} = \frac{{\sum }_{i} {N}_{i} {M}_{i}^{2}}{{\sum }_{i} {N}_{i} {M}_{i}} ,$$

wherein Nᵢ is the number of molecules of molecular weight Mᵢ. Intuitively, if the weight average molecular weight is w, and you pick a random monomer, then the polymer it belongs to will have a weight of w on average. The weight average molecular weight can be determined by light scattering, small angle neutron scattering (SANS), X-ray scattering, and sedimentation velocity.

As used herein, the terms “polydispersity” and “polydispersity index” refer to the ratio of the weight average to the number average (M_{w}/Mₙ).

As used herein, the term “semiconductor” is intended to refer to a material that exhibits a conductance in between that of a conductor and an insulator. Examples of semiconductors include, but are not limited to, an n-type semiconductor, a p-type semiconductor, or a materials that exhibits characteristics of both an n-type semiconductor and a p-type semiconductor.

As used herein, the term “photon absorber” is intended to refer to a material that is capable of absorbing at least one photon. Included within a photon absorber is a multi-photon absorber (e.g., a two-photon absorber).

### B. COMPOUNDS

In one aspect, a compound comprises at least one semiconductor; and a polymerizable residue covalently bound thereto. In one aspect, a semiconductor can be an n-type semiconductor, or a p-type semiconductor, or a combination thereof. An n-type semiconductor can be an electron transport material. Thus, the n layer in a semiconducting device can have a balance of negative charge. A p-type semiconductor can be a hole transport material. Thus, the p layer in a semiconducting device can have a balance of positive charge (or the absence of negative charge).

In a further aspect, a semiconductor can be both an n-type semiconductor and a p-type semiconductor. A semiconductor exhibiting characteristics of both n-type and p-type semiconductors would fall within this category. An example of such a semiconductor is an i-type conductor (intrinsic semiconductor), which can generally comprise an equal amount of holes and electrons. An i-type semiconductor can be used as a heterojunction material in a photovoltaic device, for example.

In one aspect, the at least one semiconductor is an n-type semiconductor. An n-type semiconductor can exhibit a number of properties that can be useful in an electronic or electro-optical device. In some aspects, the presence of the semiconductor in the compound can determine or influence an electrical or optical exhibiting by the compound. An example of such a property is hole mobility. In one aspect, the compound exhibits a hole mobility of at least about 0.02 cm² V⁻¹ s⁻¹. In a further aspect, the compound exhibits a hole mobility of from about 0.02 cm² V⁻¹ s⁻¹ to about 3 cm² V⁻¹ s⁻¹. It understood that a hole can be the mathematical opposite of an electron, or the absence of an electron, including a cation, and the like.

In a still further aspect, a compound can have one or more desirable optical properties. An example of such a property is the fluorescence quantum yield, which is defined as the ratio of the number of photons emitted to the number of photons absorbed by the compound. In one aspect, the compound can have a fluorescent quantum yield (φ_{F}) of at least about 0.95. In a further aspect, the compound can have a fluorescent quantum yield (φ_{F}) of at least about 0.99. Thus, in some aspects, the compound can have a fluorescent quantum yield that approaches unity.

In yet a further aspect, a compound can have a desirable molar absorptivity. In one aspect, the compound can have a molar absorptivity of at least about 80,000 L mol⁻¹ cm⁻¹.

In one aspect, a compound can have a desirable electronic property. An example of such a property of the optical band gap, or the energy difference between the top of the valence band and the bottom of the conduction band. In one aspect, the compound can exhibit an optical band gap of from about 2 eV to about 3 eV. In a further aspect, the compound can exhibit an optical band gap of from about 2 eV to about 2.5 eV.

In a further aspect, a compound can have a desirable redox potential. Such a property can be determined by cyclic voltammetry. During cyclic voltammetry, a reduction of the compound begins to occur and the current can rise with increasing negative potential. On the other hand, at a sufficient potential the current starts to decrease like in chronocoulometry due to the growth of the diffusion layer into the solution. These contrary processes overlap to a resulting wave with a maximum current at a peak potential often called E_{P}. The current of the redox process (also called faradayic current) is proportional to the square root of the scanning speed v. By changing the direction of the potential (i.e. scanning back to the starting value) the reduced compound is re-oxidised again, if the redox reaction is electrochemically reversible. This results in a second wave. The (half way) Potential (often called E_{1/2}) of a reversible redox process is equal to E₀. E_{1/2} can be determined by adding the peak potentials E_{P} of the forward and backward scan and dividing by two. In one aspect, the compound can exhibit a half way potential versus Ferrocene/Ferrocene⁺(E_{1/2}) of from about −1.5 V to about −1 V.

In one aspect, a semiconductor present in a compound can be an organic semiconductor comprising from 1 to 80 carbons. For example, the semiconductor can be an organic semiconductor comprising from 1 to 60 carbons, 1 to 40 carbons, 1 to 30 carbons, 1 to 20 carbons, or 1 to 10 carbons. An organic semiconductor can be an at least partially conjugated semiconductor comprising from 1 to 80 carbons. For example, the semiconductor can be an at least partially conjugated semiconductor comprising from 1 to 60 carbons, 1 to 40 carbons, 1 to 30 carbons, 1 to 20 carbons, or 1 to 10 carbons.

In one aspect, a semiconductor can be selected from optionally substituted aryl, and optionally substituted heteroaryl. Suitable examples of semiconductors that comprise these structural motifs include optionally substituted C₆₀ residue, optionally substituted perylene residue, optionally substituted pentacene residue, optionally substituted porphyrin residue, optionally substituted thiophene, and optionally substituted thiazole. In one aspect, optionally substituted C₆₀ residue, optionally substituted perylene residue, optionally substituted pentacene residue, optionally substituted porphyrin residue, optionally substituted thiophene, and optionally substituted thiazole can be present as an n-type semiconductor. Other n-type semiconductors include at least partially fluorinated pentacene residue, optionally substituted bithiazole or a residue thereof, and optionally substituted perylene residue (e.g., optionally substituted perylene diimide residue).

In one aspect, an optionally substituted C₆₀ residue can comprise a residue represented by a formula:

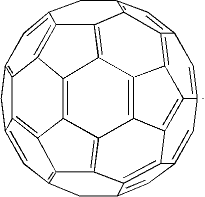

In one aspect, an optionally substituted thiazole can comprise a residue represented by a formula:

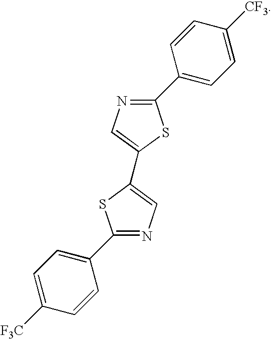

In one aspect, a residue can comprise an optionally substituted macrocyclic compound, such as for example, a porphine, porphyrin, or a phthalocyanine. In another aspect, an optionally substituted phthalocyanine can comprise a residue represented by a formula:

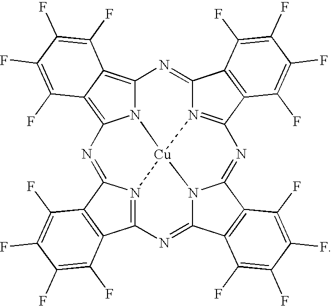

In one aspect, an optionally substituted pentacene residue can comprise a residue represented by a formula:

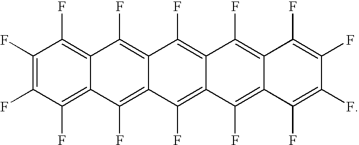

In a further aspect, the semiconductor can comprise a perylene diimide residue selected from:

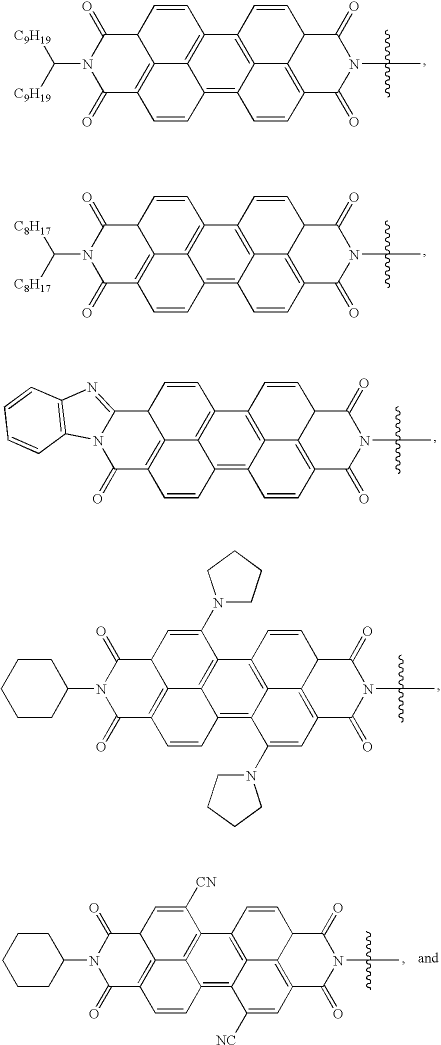

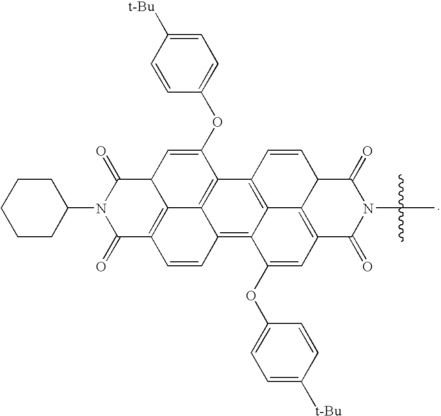

It is understood that

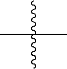

is intended to refer to an additional residue of the compound that is not shown. For example, the above perylene diimides can be bound to another residue, such as, for example, a polymerizable residue, at the indicated

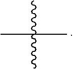

Such representation of a disclosed compound can be applied throughout this specification.

In one aspect, a perylene diimide can be covalently bound to a polymerizable residue. For example, the compound can comprise a structure represented by a fornula:

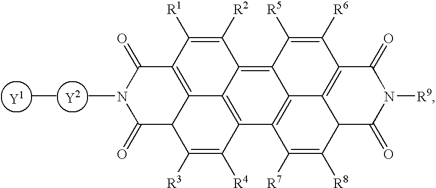

wherein Y¹ is the polymerizable residue; wherein Y² is a linking group that is either present or absent; and wherein R¹, R², R³, R⁴, R⁵, R⁶, R⁷, R⁸, and R⁹ are independently selected from hydrogen, thiol, cyano, hydroxyl, amido, halogen, optionally substituted alkyl, optionally substituted cycloalkyl, optionally substituted heterocycloalkyl, optionally substituted aryl, and optionally substituted heteroaryl.

It will be apparent that through the modification of R¹, R², R³, R⁴, R⁵, R⁶, R⁷, R⁸, and R⁹, molecular orbital energies of a perylene diiimde can be tuned. Examples of such compounds include, but are not limited to, perylene diimides known as PDI-B1, PDI-C9, PDI-CN, and 5-PDI, which are represented by the structural formulae (respectively):

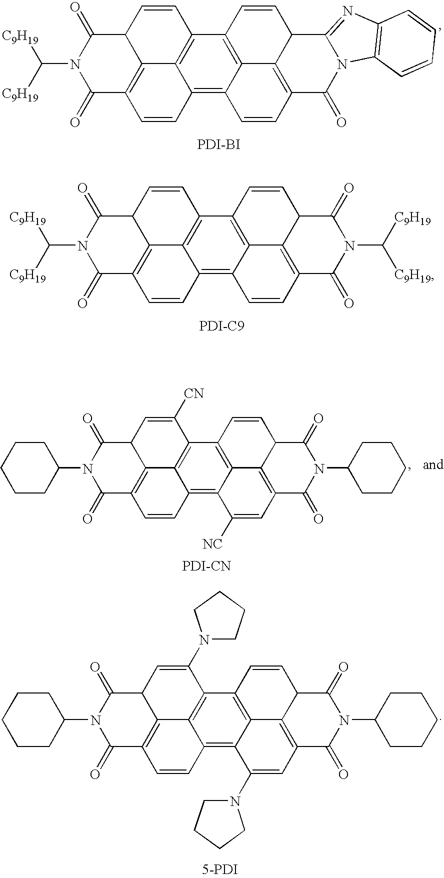

PDI-B1, PDI-C9, PDI-CN, and 5-PDI have varying molecular orbital energies, which can affect the band gap of these compounds, which are illustrated in FIG. 2. In general, the nature of the band gap is at least partially dependent on the electron donating and/or electron withdrawing ability of groups R¹, R², R³, R⁴, R⁵, R⁶, R⁷, R⁸, and R⁹. These compounds are described in more detail in J. Mater. Chem. 2006, 16, 384-390, the disclosure of which is hereby incorporated into this specification by reference.

In one aspect, the linking group Y² is absent. In the alternative, Y² can be present. For example, Y² can be selected from optionally substituted alkyl and optionally substituted heteroalkyl. It should be appreciated that the nature of the polymerizable residue, if present, can dictate the desirability and/or nature of the linking group Y². For example, if a polymerization method is sensitive to large bulky side-chains, a linking group Y² can be integrated in the compound to ensure the de-coupling of the side-chain and the growing polymer. An example of a polymerization method that can be sensitive to bulky side-chains is ring-opening metathesis polymerization (ROMP). In one aspect Y² is present and can be selected from optionally substituted alkyl and optionally substituted heteroalkyl.

In one aspect, a perylene diimide can be covalently bound to an olefin. In general, if metathesis is the polymerization method, the nature of the polymerization can determine the type of monomer employed. For example, if ROMP is used, then norbornene can be the monomer. For example, the compound can comprise a structure represented by a formula:

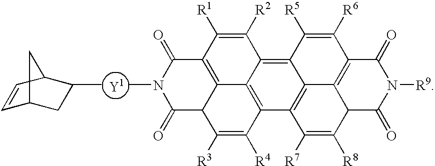

In one aspect, the compound can comprise a structure represented by a formula:

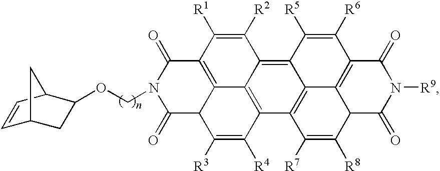

wherein n is an integer from 1 to 12. In another aspect, n is an integer greater than 12.

In a specific aspect, the compound can be present as:

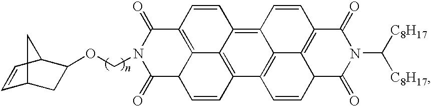

wherein n is an integer from 1 to 12. For example, in this instance, n can be 1, 2, 3, 4, 5, 6, 7, 8, 9, 10, 11, or 12. In other aspects, n can be greater than 12.

In one aspect, the at least one semiconductor can have one or more electronic or optical properties that are at least partially dependent on the conformation of the at least one semiconductor. It will be apparent that in some aspects, such a characteristic can be exploited by the present invention. For example, the conformation of a small molecule semiconductor can be manipulated through the use of a polymer bound thereto. In some instances, the presence of the polymer can align a semiconductor in an appropriate conformation so as to at least partially affect a property, such as, for example, a charge transfer property. An example of a compound that can be exhibit conformational dependent properties is a perylene diimide residue.

In one aspect, the at least one semiconductor can be ap-type semiconductor. It is contemplated that any suitable p-type semiconductor can be used with the present invention. In general, a suitable p-type semiconductor can be a semiconductor with a desirable hole and/or electron mobility.

In one aspect, the at least one semiconductor comprises one or more optionally substituted thiophene residues. A thiophene residue can be, for example, a p-type semiconductor. In a further aspect, the at least one semiconductor can comprise a polythiophene residue. For example, the at least one semiconductor can comprise a structural residue represented by a formula:

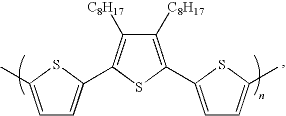

wherein n is an integer selected from 1, 2, 3, 4, and 5. For example, n can be 2. Such a residue can, in some aspects, be covalently bound to a polymerizable residue through any appropriate linking group at any appropriate position, examples of which will be discussed further herein.

In one aspect, a compound can comprise a structure represented by a formula

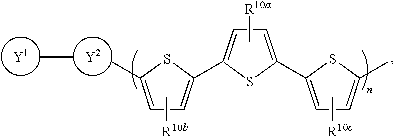

wherein Y¹ is the polymerizable residue; wherein Y² is a linking group that is either present or absent; wherein n is an integer selected from 1, 2, 3, 4, and 5; and wherein each R^{10a}, R^{10b}, and R^{10c} independently comprises two substituents selected from hydrogen, cyano, halogen, thiol, hydroxyl, and optionally substituted alkyl.

In one aspect, the linking group Y² is absent. In the alternative, Y² can be present. For example, Y² can be selected from optionally substituted alkyl and optionally substituted heteroalkyl. It should be appreciated that the nature of the polymerizable residue, if present, can dictate the desirability and/or nature of the linking group Y². For example, if a polymerization method is sensitive to large bulky side-chains, a linking group Y² can be integrated in the compound to ensure the de-coupling of the side-chain and the growing polymer. An example of a polymerization method that can be sensitive to bulky side-chains is ring-opening metathesis polymerization (ROMP). In one aspect, Y² is present and is selected from optionally substituted alkyl and optionally substituted heteroalkyl.

In one aspect, a thiophene residue can be covalently bound to an olefin. In general, if metathesis is the polymerization method, the nature of the polymerization can determine the type of monomer employed. For example, if ROMP is used, then norbornene can be the monomer. For example, the compound can comprise a structure represented by a formula:

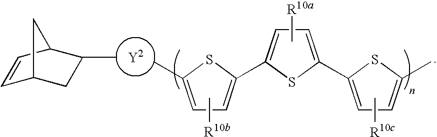

In a further aspect, a compound can comprise a structure represented by a formula:

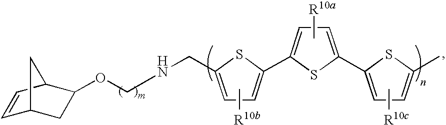

wherein m is an integer from 1 to 12. For example, m can be 1, 2, 3, 4, 5, 6, 7, 8, 9, 10, 11, or 12. In other aspects, n can be greater than 12.

In a specific aspect, a compound can be present as:

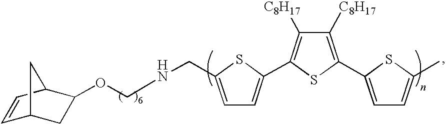

wherein n is 2.

In one aspect, the at least one semiconductor can be both an n-type semiconductor and a p-type semiconductor.

In a further aspect, the at least one semiconductor can comprise an optionally substituted 2,3-di(pyridin-2-yl)quinoxaline residue. In one aspect, an optionally substituted 2,3-di(pyridin-2-yl)quinoxaline residue can be both an n-type semiconductor and a p-type semiconductor.

For example, the at least one semiconductor can comprise a structure represented by a formula:

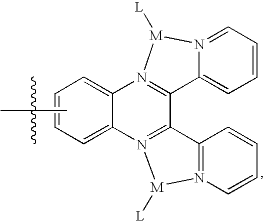

wherein M is a transition metal; and wherein L is at least one ligand comprising an organic residue comprising from 1 to 12 carbons; or a salt thereof. In other aspects, L can comprise at least one ligand comprising an organic residue comprising greater than 12 carbons; or a salt thereof. Depending on the metal and oxidation state thereof, various salts can be present. Generally, the metal can comprise a cation with a given charge (i.e., Mⁿ⁺) stabilized by any anion (e.g., Aⁿ⁻). Examples of suitable anions include, but are not limited to, PF₆⁻, Bar_{F}⁻, BF₄⁻, Cl⁻, OTf⁻, and the like.

In one aspect, M can be Ru. In a further aspect, L can be optionally substituted (phen)₂, wherein “phen” refers to phenanthroline. In a still further aspect, the compound can comprise a structure represented by a formula:

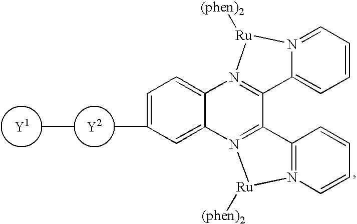

wherein Y¹ is the polymerizable residue; and wherein Y² is a linking group that is either present or absent.

In one aspect, the linking group Y² is absent. In the alternative, Y² can be present. For example, Y² can be selected from optionally substituted alkyl and optionally substituted heteroalkyl. It should be appreciated that the nature of the polymerizable residue, if present, can dictate the desirability and/or nature of the linking group Y². For example, if a polymerization method is sensitive to large bulky side-chains, a linking group Y² can be integrated in the compound to ensure the de-coupling of the side-chain and the growing polymer. An example of a polymerization method that can be sensitive to bulky side-chains is ring-opening metathesis polymerization (ROMP). In one aspect, Y² is present and is selected from optionally substituted alkyl and optionally substituted heteroalkyl.

In one aspect, a thiophene residue can be covalently bound to an olefin. In general, if metathesis is the polymerization method, the nature of the polymerization can determine the type of monomer employed. For example, if ROMP is used, then norbornene can be the monomer. For example, the compound can comprise a structure represented by a formula:

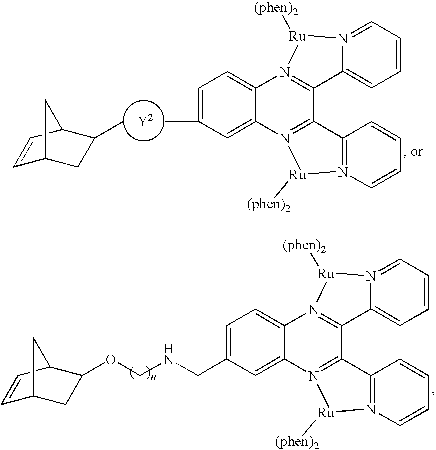

wherein n is an integer from 1 to 12. In other aspects, n can be greater than 12.

For example, a compound can be present as:

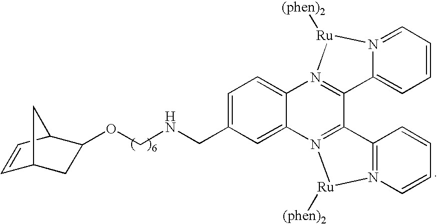

In one aspect, a disclosed compound can comprise any polymerizable residue compatible with a pendant semiconductor residue. In one aspect, the polymerizable residue can be an organic residue comprising from 1 to 26 carbons, including, for example, 1 to 18 carbons, and 1 to 12 carbons.

In a further aspect, the polymerizable residue can comprise optionally substituted alkyl, optionally substituted alkenyl, or optionally substituted alkynyl. In a still further aspect, the polymerizable residue comprises optionally substituted aryl alkyl, optionally substituted aryl alkenyl, or optionally substituted aryl alkynyl. In yet a further aspect, the polymerizable residue can comprise optionally substituted cycloalkenyl, or optionally substituted heterocycloalkenyl. For example, the polymerizable residue can comprise a conformationally strained olefin residue.

In one aspect, the polymerizable residue can comprise optionally substituted amide, optionally substituted ester, optionally substituted urethane, optionally substituted siloxane, optionally substituted phenol, optionally substituted urea, optionally substituted sulfide, optionally substituted acetal, optionally substituted ethylene, optionally substituted isobutylene, optionally substituted vinyl chloride, optionally substituted styrene, optionally substituted methyl methacrylate, optionally substituted vinyl acetate, optionally substituted vinylidene chloride, or optionally substituted isoprene.

In a further aspect, the polymerizable residue can comprise optionally substituted cyclopentene, norbornene, optionally substituted bicyclo[2.2.1]hepta-2,5-diene cyclooctatetraene, cyclooctyne, or cis-cyclooctene. In a specific aspect, the polymerizable residue can comprise optionally substituted norbornene. For example, the polymerizable residue can comprise a substantially pure exo isomer of optionally substituted norbornene.

In one aspect, the polymerizable residue can be capable of being polymerized in a substantially living fashion, as defined herein.

A disclosed compound can also function as an absorbing material if such a property is desired. For example, if a disclosed polymer or compound is to be incorporated into a photovoltaic device, the at least one semiconductor, in one aspect, can be the photon absorbing material. In a further aspect, the at least one semiconductor can function as a two photon absorbing material.

It is understood that any of the aforementioned compounds, semiconducting residues, polymerizable residues, linking groups, and the like can be used in combination with the methods, uses and devices.

### C. METHODS OF MAKING THE COMPOUNDS

A disclosed compound can be made by methods known in the art, or by methods presently disclosed. Generally, in one aspect, synthesis of a disclosed compound can comprise providing the semiconducting residue of the compound or a precursor thereof, providing the polymerizable residue of the compound or a precursor thereof, and subsequently reacting the semiconducting residue or a precursor thereof with the polymerizable residue or a precursor thereof. If either the semiconducting residue or the polymerizable residue is present as a precursor thereof, additional steps can be carried out to arrive that the target compound. It is understood that steps of such a general synthesis can occur in any order.

In one aspect, a semiconducting residue or a precursor thereof and a polymerizable residue or a precursor thereof can be coupled together through, for example, but not limited to, one of the following synthetic methods: nucleophilic substitution, electrophilic aromatic substitution, “click” chemistry, including the 1,3-Huisgan cycloaddition, transition metal couplings, “Wittig” and “Wittig” type couplings, Grignard couplings, and other addition and substitution type reactions.

In one aspect, a disclosed compound can be provided by a process according to Scheme 1.

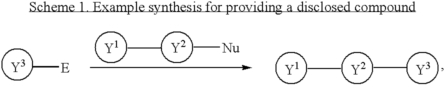

wherein E is an electrophile, Nu is a nucleophile, and Y¹ is the polymerizable residue, Y² is an optionally present linking group, and Y³ is the semiconducting residue.

In one aspect, for example, if a perylene diimide is selected as the at least one semiconductor, the perylene diimide can be provided according to Scheme 2.

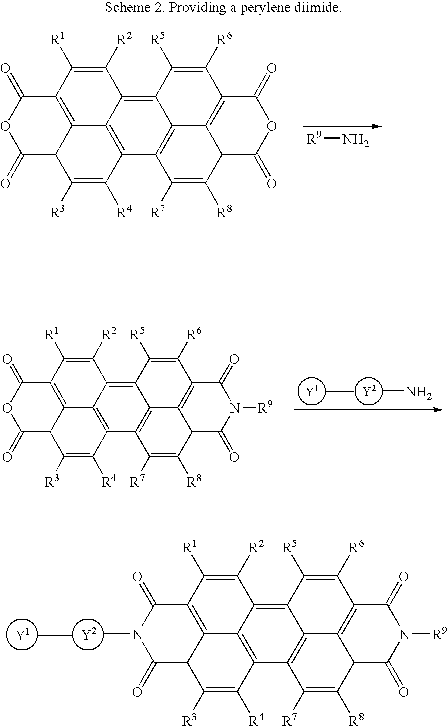

It will be apparent that the above Scheme 1 can be adapted and applied to a variety of polymerizable residues and semiconducting residues disclosed herein. Specifically, Scheme 2 can be used to provide any disclosed perylene diimide compound. A variety of specific conditions can be used according to Scheme 2. For example, R⁹—NH₂ can be added using imadazole as a base and heating to about 160° C. for about 4 hr. The second step can be accomplished by refluxing in toluene, for example. It will also be apparent that there can be multiple pathways to produce any of the desired compounds and/or intermediates and that one of skill in the art in possession of this disclosure could readily select an appropriate reaction pathway.

In one aspect, for example, if a thiophene based compound is selected, the thiophene based compound can be provided according to Scheme 3.

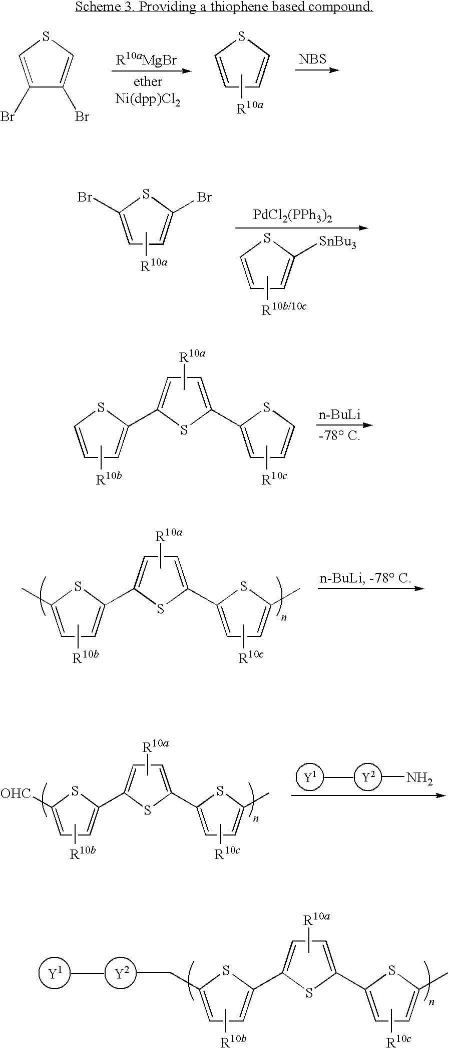

It will be apparent that the above Scheme 3 can be adapted and applied to a variety of polymerizable residues and semiconducting residues disclosed herein. Specifically, Scheme 3 can be used to provide any disclosed thiophene based compound (e.g., a polythiophene). In step four of Scheme 3, a coupling agent can be desirable. One of skill could readily select an appropriate coupling reagent. In step four of Scheme 3, a quenching agent can be used. Any suitable quenching agent can be used, for example DMF.

In one aspect, for example, if a metal containing compound is selected, the metal containing compound can be provided according to Scheme 4. It should be noted that if a metal containing compound is used, the metal containing compound can contain 1 metal atom, 2 metal atoms, or 3 or more metal atoms, wherein each metal atom can comprise the same or different metal.

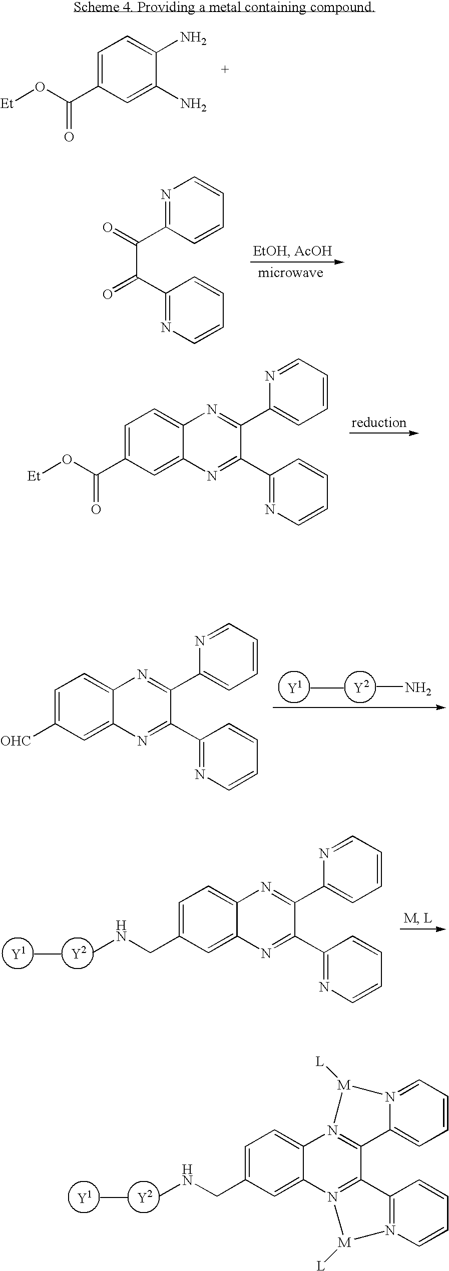

It will be apparent that the above Scheme 4 can be adapted and applied to a variety of polymerizable residues and semiconducting residues disclosed herein. Specifically, Scheme 4 can be used to provide any disclosed metal containing compound.

A polymerizable portion of a disclosed compound can be provided by methods known in the art, or through methods presently disclosed. Various monomers and monomer precursors are available from commercial sources.

If a cyclic olefin is chosen as the polymerizable residue, the cyclic olefin can be provided by methods known in the art, or by methods presently disclosed. A variety of norbornene based monomers can be provided by providing cyclopentadiene (e.g., from cracking dicyclopentadiene) and reacting the cyclopentadiene with an appropriate dienophile in a Diels-Alder fashion. For example, this process can be used to provide norbornene carboxylic acid through the use of acrylic acid as the dienophile. In this case, the pure exo-isomer of the resulting norbornene compound can be provided by a subsequent iodolactonization reaction, which removes the endo-isomer.

In a further aspect, bicyclo[2.2.1]hepta-2,5-diene can undergo an addition reaction with a suitable reagent, such as, for example, acetic acid. The product of this reaction can be used to provide a variety of norbornene based monomers. An exemplary monomer can be providing according to Scheme 5.

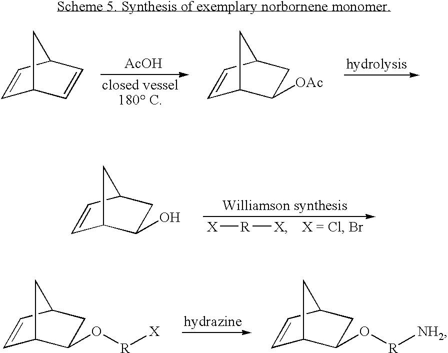

wherein R can be any optionally substituted alkyl.

It will be apparent that the above Scheme 5 can be adapted and applied to a variety of polymerizable residues and semiconducting residues disclosed herein. Specifically, Scheme 5 can be used to provide a disclosed compound comprising a norbornene based polymerizable residue.

It is understood that the methods can be used in combination with the disclosed compounds, polymers, uses thereof, and devices.

### D. POLYMERS

In one aspect, a polymer can be the polymer of a disclosed compound. Likewise, a polymer can comprise the compound or a residue thereof of any of the disclosed compounds. In one aspect, a polymer can comprise at least one semiconductor covalently bound to one or more side-chains thereof. In a further aspect, the polymer can be a copolymer, such as, for example, a random copolymer, a blocky copolymer, a block copolymer, a di-block copolymer, a tri-block copolymer, or a higher order block copolymer.

In one aspect, a di-block copolymer can be capable of at least partial phase separation. Thus, in one aspect, a di-block copolymer can be phase separated. In a further aspect, a tri-block copolymer can be capable of at least partial phase seperation. Thus, in one aspect, a tri-block copolymer can be phase separated. For example, a di- or tri-block copolymer can be phase separated in a device. Phase separation in a block copolymer can be related to the phase diagram of the block copolymer, wherein various ratios of each block determine what type of phase separation can be achieved. An example, with reference to a tri-block copolymer, is discussed in Ludwigs et al., Polymer, 2003, 44, 6815, which is incorporated herein by this referecence. In this work, it was shown that with decreasing poly(tert-butyl methacrylate) volume fraction, polymer morphologies could be changed from core-shell cylinders (poly-styrene core surrounded by a poly(2-vinylpyridine) shell in a poly(tert-butyl methacrylate) matrix) via a core-shell gyroid (in coexistence to the metastable perforated lamellar phase) to a lamellar structure. In these studies, various morphologies could be attained, including cylinder core, gyroid core, and lamellar phase.

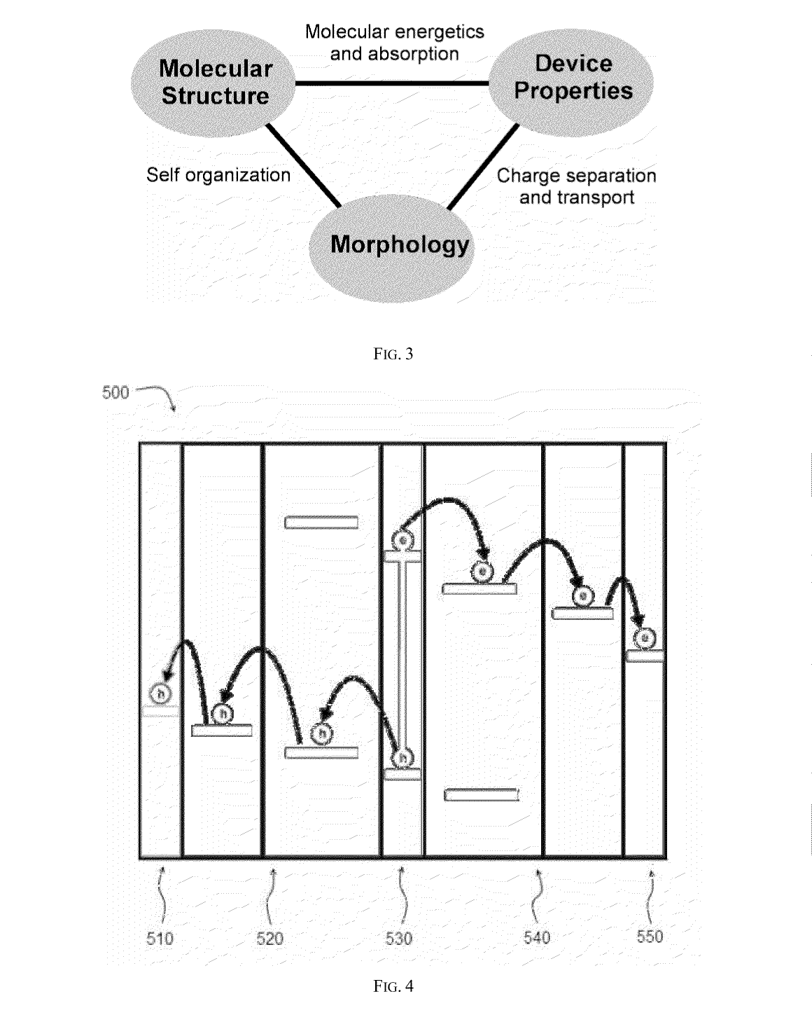

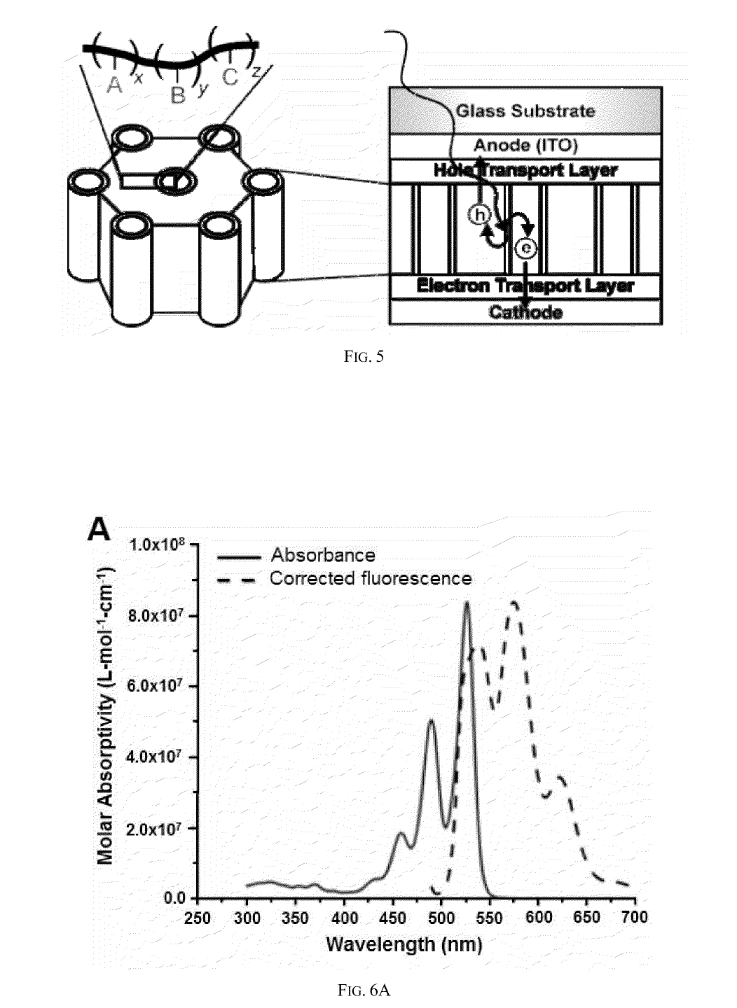

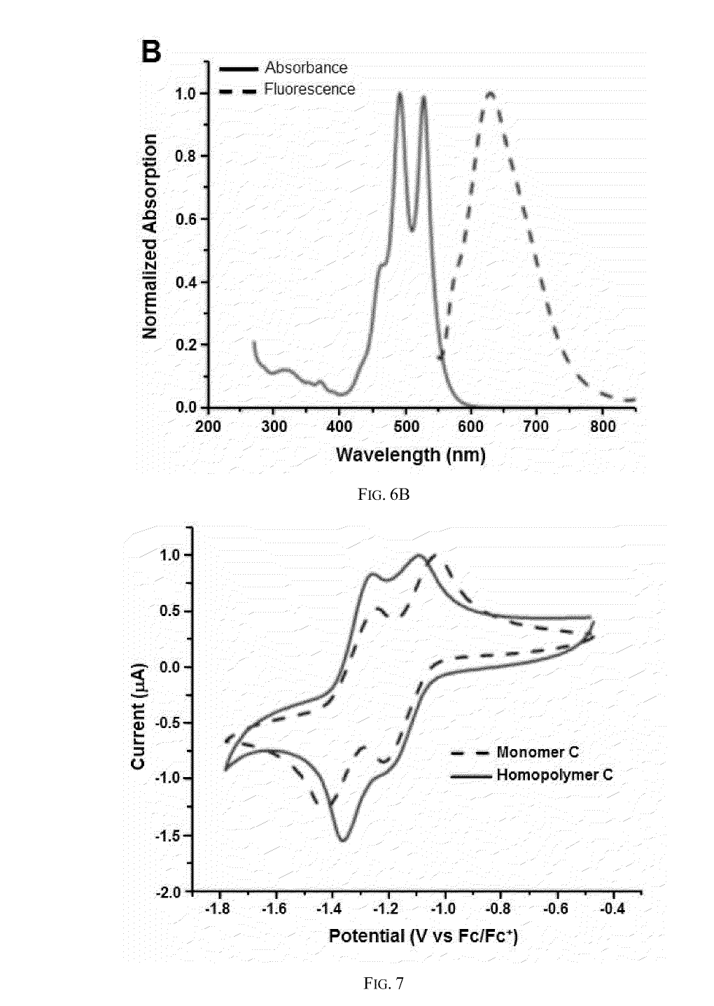

If a disclosed polymer is to be used in a device, for example, phase separation can be used to enhance or augment device properties. In general, in terms of devices comprising block copolymers, a relationship exists between molecular structure, polymer morphology, and device properties, as is illustrated in FIG. 3.

In one aspect, a polymer can comprise a polystyrene block. In the alternative, in one aspect, a polymer does not comprise a polystyrene block. Likewise, in one aspect, a polymer does not comprise a polyacrylate comprising perylene bisimide.

In one aspect, a polymer can further comprise a photon absorber or other functional component, depending on a selected device application. For example, a disclosed polymer can comprise a light aborbing material if the device application is related to photovoltaics, and the like. In one aspect, a disclosed compound can be a photon absorber. In a further aspect, a disclosed compound or polymer thereof can function as both a photon absorber and a semiconductor. In one aspect, a photon absorber can be a two-photon absorber.

It will be apparent that a variety of polymers can be generated from the disclosed compounds. If, for example, ring-opening metathesis polymerization is used to polymerize a norbornene based monomer, then the can be provided according to Scheme 6.

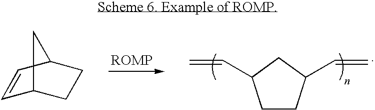

Thus, any disclosed norbornene based compound can provide a polymer as represented in Scheme 6. For example, in one aspect, the polymer can comprise a structure represented by a formula:

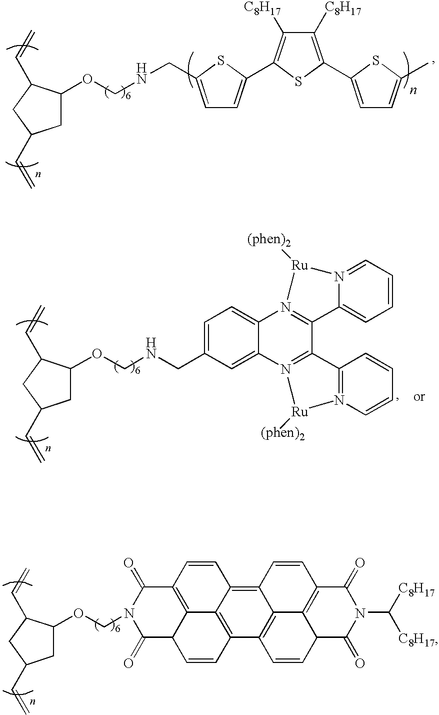

wherein n is an integer from 1 to 100,000; or a copolymer thereof.

In a further aspect, the polymer can be present as:

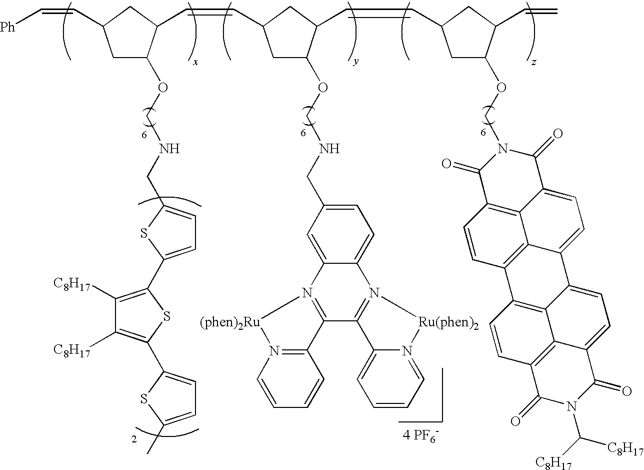

wherein x, y, and z, are integers independently selected from 1 to 100,000.

In a further aspect, the polymer can be present as:

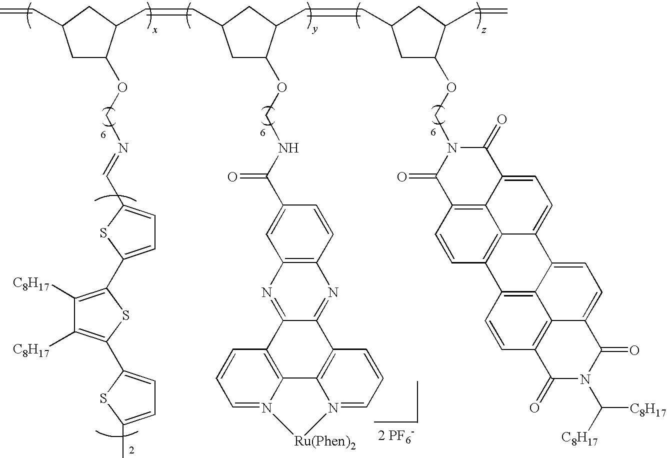

In a further aspect, the following polymerizable residues can be used:

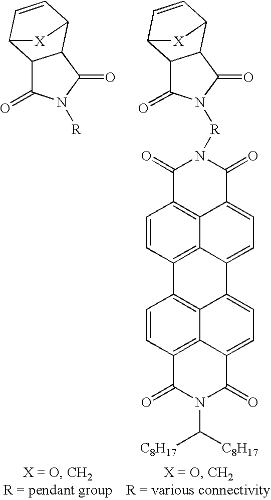

In a further aspect, the polymer can be present as:

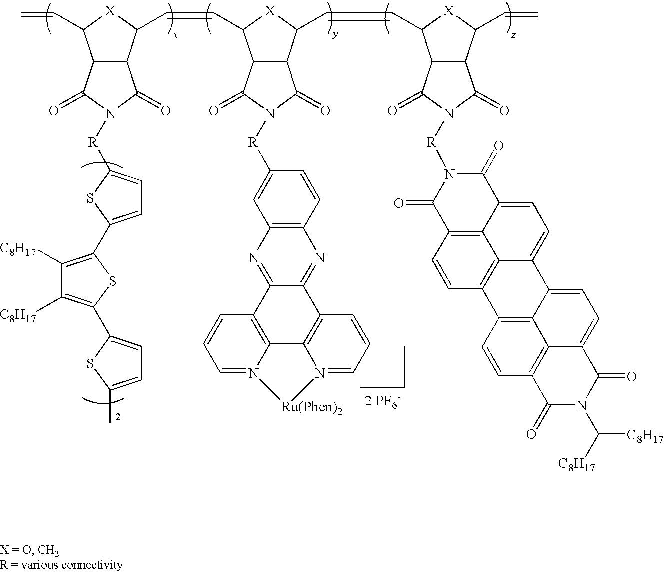

In one aspect, a polymer can have any suitable molecular weight. In some aspects, it can be desirable for a polymer to have a molecular weight that is suitable for film formation if, for example, the polymer will be incorporated into a device as a film. If the polymer is a tri-block copolymer, for example, the type of phase separation desired can affect the selection of the molar ratio (and therefore the molecular weight) of each block. In some aspects, one block can be desired to be substantially larger than the other two blocks.

Examples of M_{w} values (in Daltons) for polymers include, but are not limited to, 2,000, 5,000, 8,000, 10,000, 15,000, 20,000, 50,000, 70,000, 80,000, 100,000, 150,000, 300,000, 400,000, and even beyond. Depending on the number average molecular weight, a polymer can exhibit any suitable polydispersity index (PDI).

In certain instances, a compound can be selected to provide a living polymer, such that block copolymer or a low polydispersity homopolymer or copolymer can be provided. A specific example of a living polymerization is the ring-opening metathesis polymerization of a norbornene based monomer, such as shown generally in Scheme 7 (Nguyen, S. T.; Johnson, L. K.; Grubbs, R. H.; Ziller, J. W. J. Am. Chem. Soc. 1992, 114, 3974-3975.). In this case, a transition metal catalyst, such as, for example, a Ru initiator (e.g., a Grubbs' intitiator) can insert into an olefin to provide a metallocyclobutene intermediate, followed by ring-opening. A growing polymer chain is said to living if that polymer chain can accept another monomer and continue to grow in a generally controlled fashion.

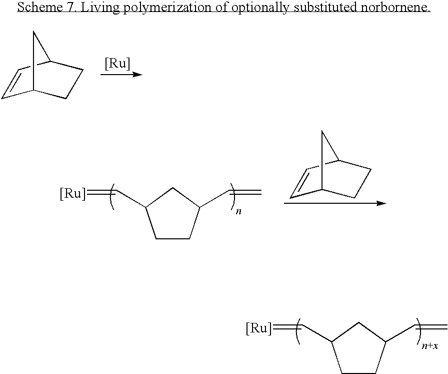

A disclosed polymer can be made by methods known in the art, or by methods presently disclosed. For example, a disclosed polyamide, polyester, polyurethane, polysiloxane, polyphenol, polyurea, polysulfide, or polyacetal can be made through a condensation polymerization. As another example, a disclosed polyethylene, polyisobutylene, polyacrylonitrile, poly(vinyl chloride), polystyrene, poly(methyl methacrylate), poly(vinyl acetate), poly(vinylidene chloride), polytetrafluoroethylene, or polyisoprene can be made through an addition polymerization.

In one aspect, ring-opening metathesis can be used to provide a disclosed polymer. Ring-opening metathesis can be carried out with a variety transition metals and transition metal complexes, including the metals, Sn, Al, W, Mo, Rh, Ru, Mo, W, and complexes thereof. Schrock type catalysts generally comprise Mo, or W. Grubbs' catalysts generally comprise Ru. In some aspects, a Ru based benzylidene or alkylidene (carbene) can be used. For example, a Ru based benzylidene or alkylidene can comprise a structure represented by one of the following formalae, known respectively as the Grubbs' 1^{st}, 2^{nd}, and 3^{rd} generation catalysts, all of which are readily commercially available.

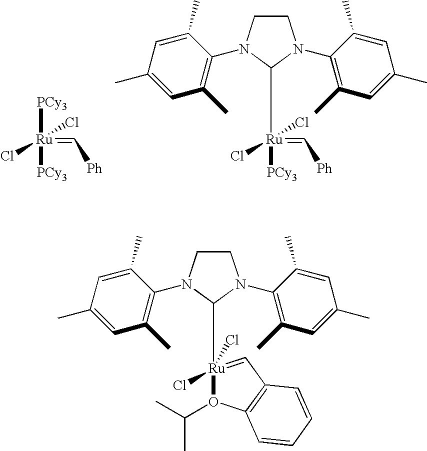

The aforementioned catalysts can be used, for example, to polymer a disclosed cycloalkene, including, but not limited to pentene, norbornene, cyclooctatetraene, cyclooctyne, or cis-cyclooctene.

### F. DEVICES

In one aspect, a device can comprise any disclosed compound and any polymer thereof. In one aspect, a device can comprise a disclosed polymer. It should appreciated that in some aspects, the use of a semiconductor covalently bound to a polymer can obviate the need for the use of complex and/or costly techniques during device production, such as, for example, vacuum deposition. For example, a polymer can allow for spin-coating.

In one aspect, the device can comprise a photovoltaic cell. Thus, in one aspect, a device can be a photovoltaic device. With reference to FIG. 4, for example, a photovoltaic device can comprise an anode (510), a hole transport or p-type layer (520), a heterojunction layer (e.g., an intrinsic layer or an i-layer) (530), an electron transport or n-type layer (540), and a cathode (550). An exemplary anode can comprise tin, such as, for example, indium-tin oxide (ITO). An exemplary cathode can comprise a conducting metal, such as, for example, Mg or Al.

With reference to FIG. 5, for example, a tri-block copolymer comprising blocks A, B, and C can be incorporated into a device of the type shown in FIG. 4. In this example, an analysis of a phase diagram and the selection of the molar ratio of each block can be used to provide a phase separated structure as shown in FIG. 5. Such a structure, for example, can be integrated into a photovoltaic device, such as the one depicted in FIG. 4, wherein block A, for example, can be present in the hole transport orp-type layer (520), wherein block B, for example, can be present in the electron transport or n-type layer (540), wherein, for example, an absorber/insulator layer (530) can be positioned between hole transport or p-type layer and the electron transport or n-type layer, and wherein an anode (510) comprises ITO, and a cathode (550) comprises Al.

### G. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. MATERIALS AND GENERAL METHODS

All chemicals were purchased from commercial suppliers and were used as received. Solvents were dried using Pure-Solv 400 solvent purification system and reactions were performed under inert atmosphere using standard Schlenk techniques except where otherwise noted. The following compounds were prepared according to modified literature procedures: 9-aminoheptadecane (Wescott, L. D.; Mattern, D. L. J. Org. Chem. 2003, 68, 10058-10066), 6-chloro-1-hexyl p-toluenesulfonate (Tomohiro, T.; Avval, P. A.; Okuno, H. Y. Synthesis 1992, 639-640), 6-(bicyclo[2.2.1]hept-5-en-2-exo-yloxy)hexylamine (Watson, K. J., Ph.D. Thesis, Northwestern University, Evanston, IL 2001), and compounds 1-3 as described in Scheme 8 (Wescott, L. D.; Mattem, D. L. J. Org. Chem. 2003, 68, 10058-10066). Column chromatography was carried out on Silicyle™ SiliaFlash™ F60, 40-63 mm 60 Å or neutral activated alumina, Brockmann I. Thin layer chromatography was performed on precoated silica gel F254 plates with fluorescent indicator or on precoated aluminum oxide IB-F plates. Visualization of non-fluorescent/non-quenching molecules was done in an I2 chamber or through a potassium permanganate dip. Deuterated solvents were purchased from Cambridge Isotope Laboratories and used without further purification.

¹H and ¹³C NMR spectra were obtained on a Varian Unity+ 300 and were referenced to the residual solvent peaks. UV/Vis spectra were recorded on a Varian Cary 6000i spectrophotometer. Fluorescent specta were measured on a Specs Fluorolog spectrophotometer.

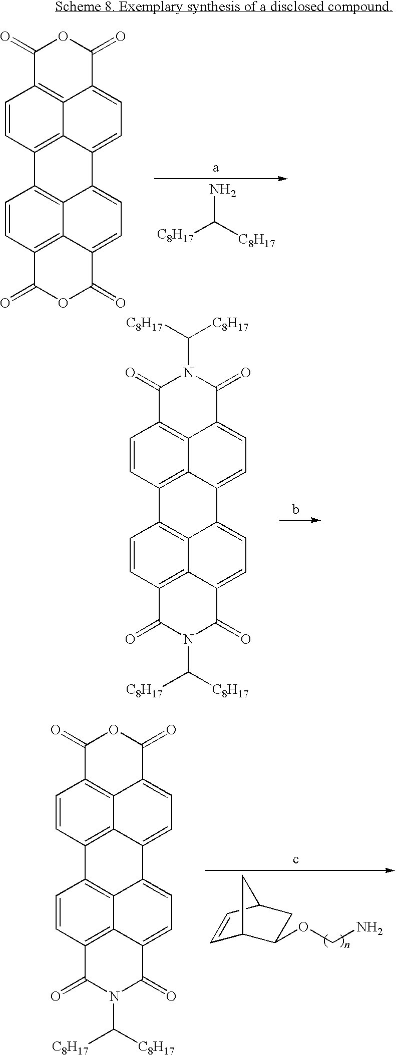

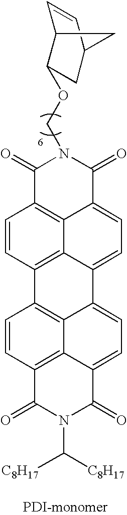

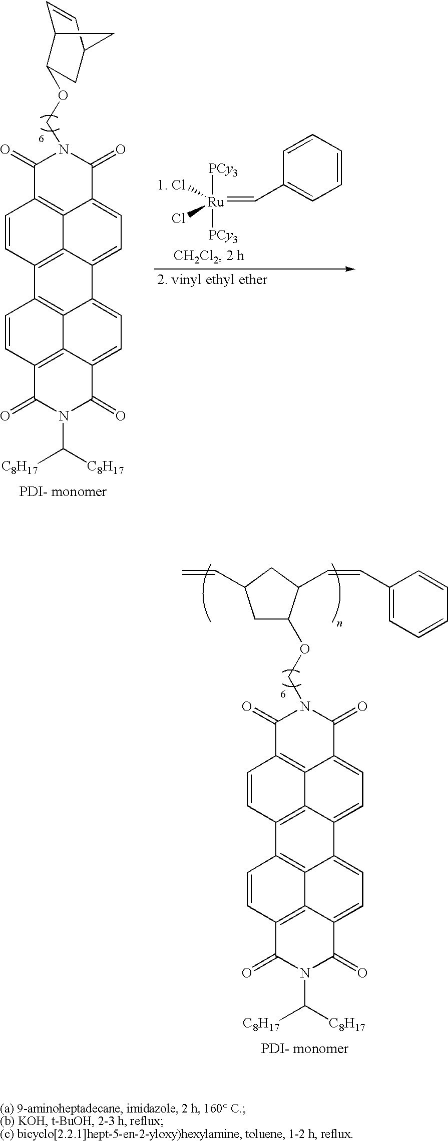

### 2. SYNTHESIS OF N,N′-DI(9-OCTYLNONYL)PERYLENE-3,4,9,10-BIS(DICARBOXIMIDE) (1)

A mixture of 3,4,9,10-perylenetetracarboxylic acid dianhydride (0.8801 g, 2.25 mmol), 9-aminoheptadecane (1.210 g, 4.71 mmol), and imidazole (4 g) was heated with stirring at 160° C. for 2 h. Upon cooling, hexanes was added to the mixture and the entire flask was sonicated. Extraction of the soluble alkylated species continued with additional hexanes until no additional color is seen when fresh hexanes is sonicated. The hexanes were removed under vacuum and chromatography (silica gel, CHCl₃) gave the target compound as the forerunner resulting in a red solid. Yield=1.03 g (53%). ¹H NMR δ (CDCl₃) 8.68-8.45 (8H, m), 5.18 (2H, m), 2.24 (2H, m), 1.87 (2H, m), 1.39-1.17 (48H, m), 0.79(12H, t). ¹³CNMR δ (CDCl₃) 164.48, 163.47, 134.31, 131.79, 131.05, 129.48, 126.27, 123.98, 123.21, 122.90, 55.07, 32.48, 32.01, 29.68, 29.38, 27.08, 22.76, 14.11.

### 3. SYNTHESIS OF N,-(9-OCTYLNONYL)-3,4,9,10-PERYLENETETRACARBOXYLIC ACID 3,4-ANHYDRIDE-9,10-IMIDE (2)

1 (1.069 g, 1.23 mmol) and KOH (0.410 g, 7.32 mmol) were added to t-BuOH (60 mL). The mixture was refluxed for 30 min. If at 30 min starting material was still visible through TLC analysis, a small amount of additional KOH was added. Upon disappearance of starting material, the reaction was allowed to cool and poured into 2M HCl (50 mL) with stirring. The resulting precipitate was filtered and rinsed with water until pH neutral. Chromatography (silica gel, CHCl₃; if further purification is needed then silica gel, 10:1 CHCl₃:AcOH) to give a reddish-brown powder. Yield=248 mg (32%). ¹H NMR δ (CDCl₃) 8.65 (8H, m), 5.20 (1H, m), 2.25 (2H, m), 1.88 (2H, m), 1.33-1.22 (24H, m), 0.85 (6H, t). ¹³CNMR δ (CDCl3) 164.42, 163.31, 135.31, 133.77, 131.92, 129.56, 126.52, 126.32, 124.28, 123.91, 123.01, 55.03, 32.51, 32.08, 29.67, 29.36, 27.05, 22.78, 14.14.

### 4. SYNTHESIS OF POLYMERIZABLE MONOMER (3)

2 (102 mg, 0.16 mmol) and 6-(bicyclo[2.2.1]hept-5-en-2-exo-yloxy)hexylamine (135 mg, 0.645 mmol) were placed into a Schlenk flask with toluene (7 mL). The reaction was brought to reflux for 2 h, or until TLC showed the disappearance of starting material 2. Upon cooling the solvent was evaporated to leave crude product. Chromatography (silica gel, 60% CH₂Cl₂ in hexanes) gave red crystals. Yield=111 mg (83%). ¹HNMR δ (CDCl₃) 8.62-8.21 (8H, m), 6.17 (1H, m), 5.88 (1H, m), 5.18 (1H, m), 4.10 (2H, t), 3.41 (3H, m), 2.82 (1H, s), 2.76 (1H, s), 2.25 (2H, m), 1.89 (2H, m), 1.78-1.12 (36H, m) 0.82 (6H, t). 13C NMR δ (CDCl₃) 140.50, 133.18, 80.15, 68.93, 46.33, 45.87, 44.98, 40.29, 34.37, 32.51, 29.83, 26.65, 25.59. UV-Vis (CHCl₃) λmax (ε): 525 nm (84,600±500 M−1 cm−1) Φ_{F} 487 nm (CHCl₃): 0.99±0.05 vs N,N′-Di(9-octylnonyl)perylene-3,4,9,10-bis(dicarboximide). LRMS (Cl+ m/z): Calc. 822, Found 822. HRMS (Cl+ CH4): CaIc. 821.4893, Found 821.4894.

### 5. POLYMERIZATION OF 3 (POLY-3)

Cl₂Ru(PCy₃)₂=CHPh, 1st generation Grubbs' catalyst, (11 mg, 0.012 mmol) was dissolved in CH₂Cl₂ (1 mL) in an inert atmosphere glove box. To this was added 3 (220 mg, 0.268 mmol) in CH₂Cl₂ (2 mL) with stirring. After 2 h, the reaction was quenched with an addition of ethyl vinyl ether. The solution was then poured into excess MeOH to precipitate the red polymer. The polymer was washed successively with MeOH (3×) and hexanes till washings were colorless.

### 6. CHARACTERIZATION OF 3 AND POLY(3)

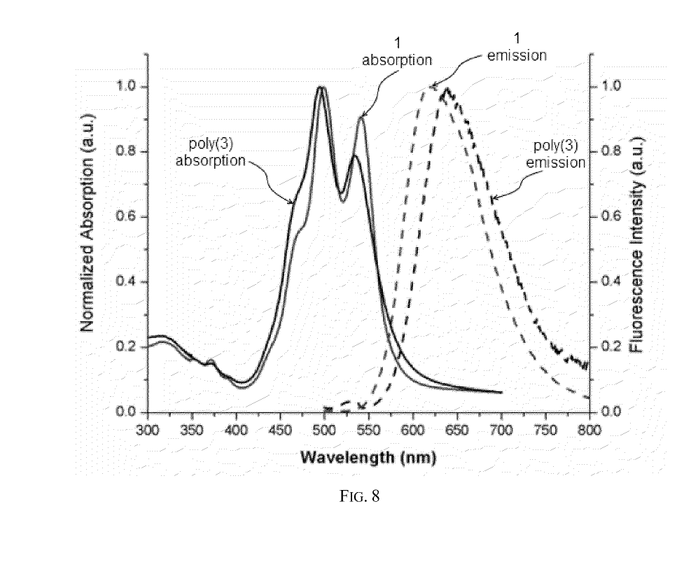

Perylene based structures are renowned for their photophysical characteristics (Langhals, H. Heterocycles 1995, 40, 477-500). The absorbance spectra of molecules based on this type of PDI structure are nearly identical for any simple alkyl substituents (Wurthner, F. Chem. Conimun. 2004, 14, 1564-1579). The UV-Vis spectra for 3 is a typical spectrum for symmetrical or unsymmetrical alkyl substituted perylene dyes with absorption maxima at 457.3, 488.0, and 526.1 nm and molar absorptivities of 1.80×104, 5.02×104, and 8.46×10⁴ L mol⁻¹ cm⁻¹ at each wavelength respectively. At the excitation wavelength of 487 nm, the fluorescent quantum yield (Φ_{F}) was found to be 0.99±0.05 versus 1, a known standard (Langhals, H.; Karolin, J.; Johansson, L. J. Chem. Soc., Faraday Trans. 1998, 94, 2919-2922). FIGS. 7A and 7B illustrate the absorbance and fluorescence of 3 (7A) and poly(3) (7B).

The electrochemical properties of 3 (monomer C) and poly(3) (homopolymer C) were measured using cyclic voltammetry. The results are plotted in FIG. 7. Table 1 lists the results.

TABLE 1
Cyclic Voltammetry results.

| | | | Optical | | |
|---|---|---|---|---|---|
| | | | band | | |
| Compound | E_{1/2}⁻¹ (V)^{a} | E_{1/2}⁻² (V)^{a} | gap (eV) | HOMO^{b} | LUMO^{b} |
| PDI-monomer | −1.12 | −1.35 | 2.35 | 5.97 | 3.62 |
| PDI-polymer | −1.17 | −1.32 | 2.34 | 5.94 | 3.60 |

^{a}Half way potentials were determined vs. Fc/Fc⁺ in 0.1 M TBAPF₆ in CH₂Cl₂.
^{b}With Fc/Fc⁺ = 4.80 eV.

### 7. FILM FORMATION AND CHARACTERIZATION

Films were made of 1 and Poly-3 by drop-casting from CHCl₃ onto quartz slides. Due to the ease that pure 1 can be obtained and the nearly identical properties, poly-3 was compared to 1 instead of 3 which can be more difficult to synthesize. The solid-state UV/Vis and emission of 1 and Poly-3 were taken as shown in FIG. 8. In the solid-state fluorescence, a significant red-shift is observed in the spectrum of Poly-3 when compared to the small molecule 1.

### 8. SYNTHESIS OF A NORBORNENE POLYMERIZABLE RESIDUE

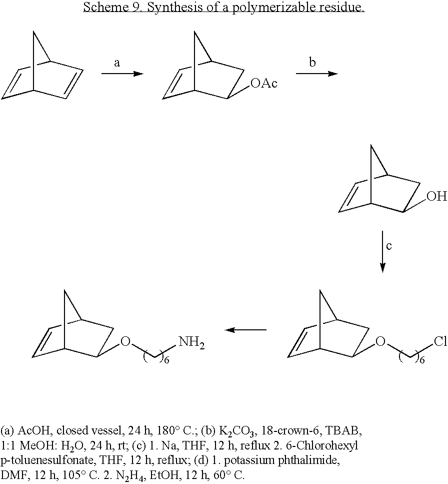

### 9. SYNTHESIS OF THIOPHENE CONTAINING COMPOUND (PROPHETIC)

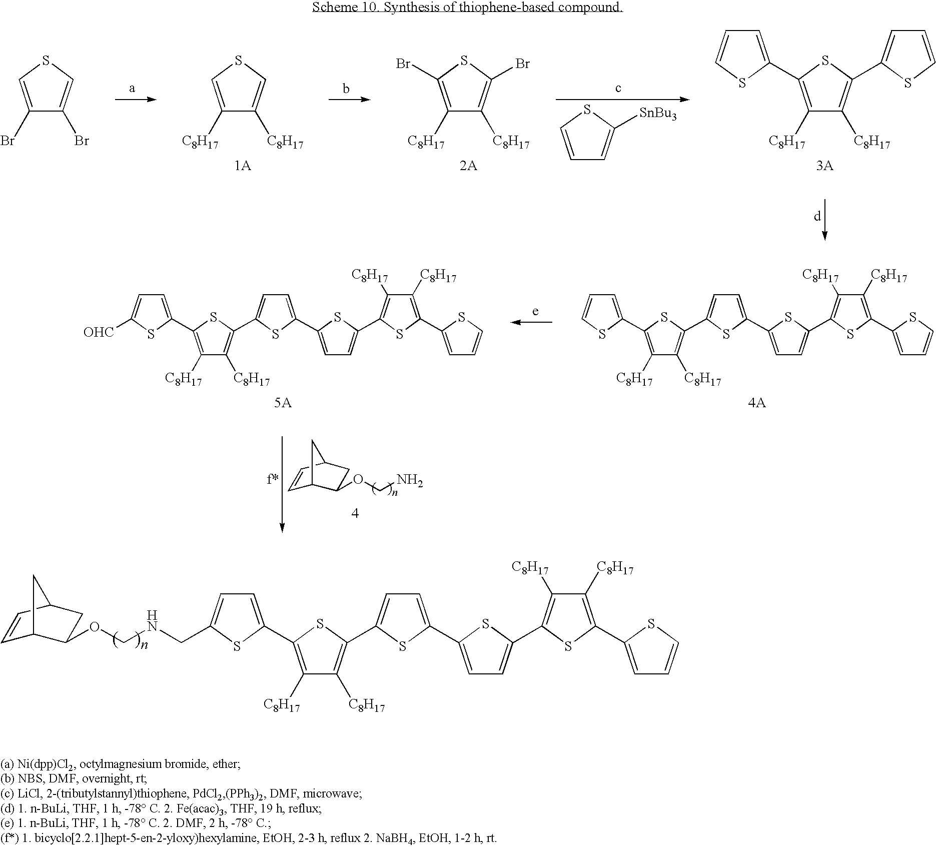

### 10. SYNTHESIS OF METAL CONTAINING COMPOUND (PROPHETIC)

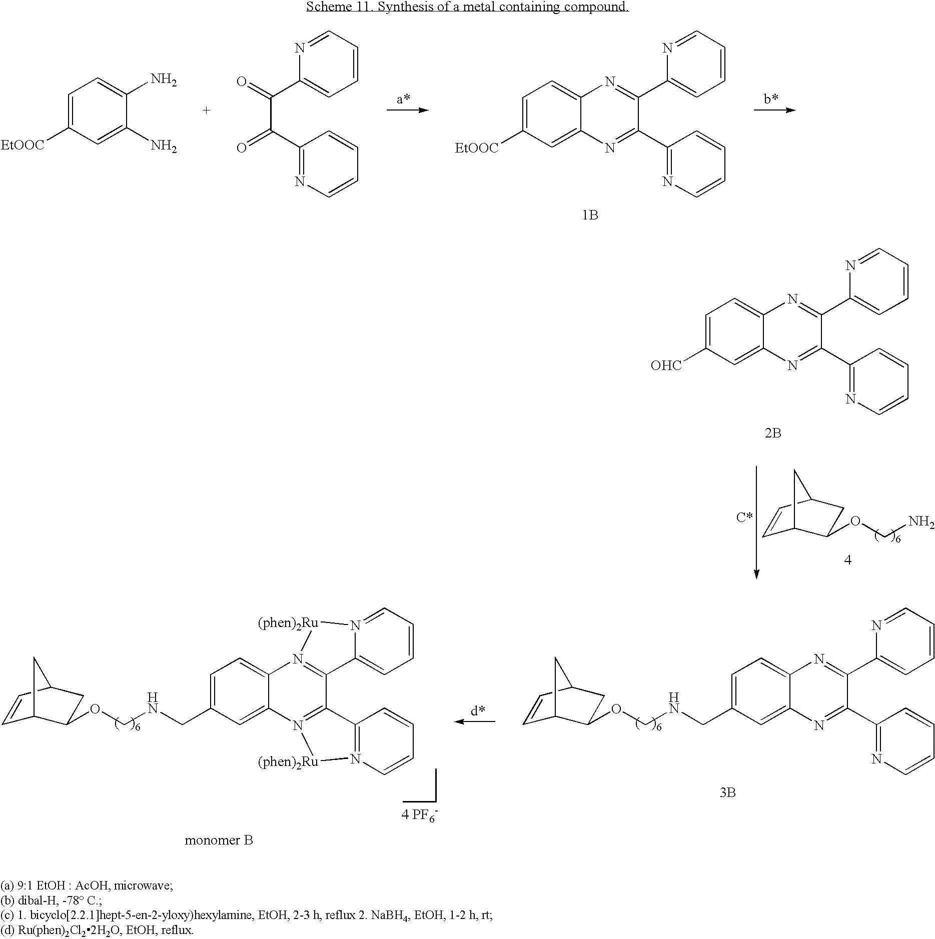

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A compound comprising: at least one semiconductor and/or a photon absorber; and a polymerizable residue covalently bound thereto.

2. The compound of claim 1, wherein the at least one semiconductor is an n-type semiconductor, a p-type semiconductor, a semiconductor that is both an n-type semiconductor and a p-type semiconductor, or a combination thereof.

3. The compound of claim 1, wherein the n-type semiconductor exhibits a band gap of from about 2 eV to about 3 eV.

4. The compound of claim 1, wherein the semiconductor comprises a residue selected from optionally substituted C₆₀ residue, optionally substituted perylene residue, optionally substituted pentacene residue, optionally substituted porphyrin residue, optionally substituted thiophene, and optionally substituted thiazole.

5. The compound of claim 1, wherein the semiconductor comprises a residue selected from:

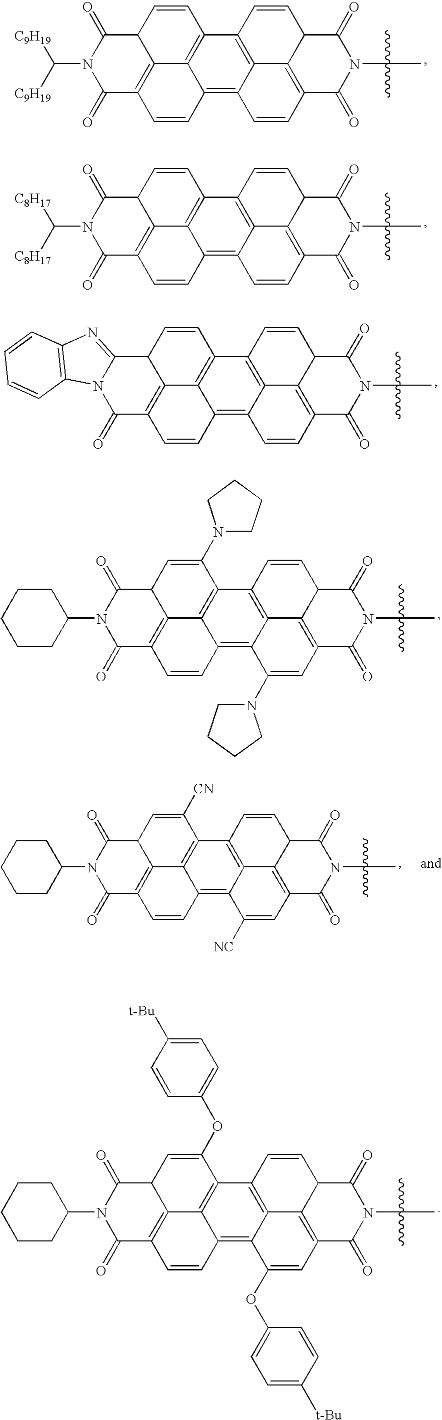

6. The compound of claim 1, wherein the compound comprises a structure represented by a formula: 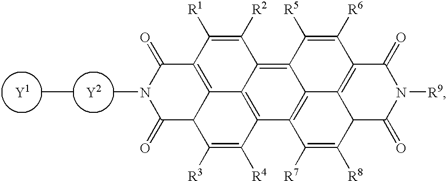
wherein Y¹ is the polymerizable residue;
wherein Y² is a linking group that is either present or absent; and
wherein R¹, R², R³, R⁴, R⁵, R⁶, R⁷, R⁸, and R⁹ are independently selected from hydrogen, thiol, cyano, hydroxyl, amido, halogen, optionally substituted alkyl, optionally substituted cycloalkyl, optionally substituted heterocycloalkyl, optionally substituted aryl, and optionally substituted heteroaryl.

7. The compound of claim 23 *6, comprising a structure represented by a formula:

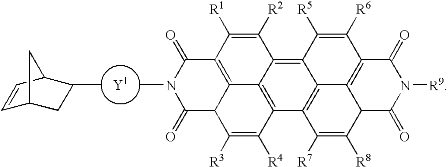

8. The compound of claim 1, wherein the at least one semiconductor comprises one or more optionally substituted thiophene residues.

9. The compound of claim 1, wherein the at least one semiconductor comprises a structural residue represented by a formula: 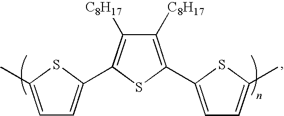
wherein n is an integer selected from 1, 2, 3, 4, and 5.

10. The compound of claim 1, comprising a structure represented by a formula 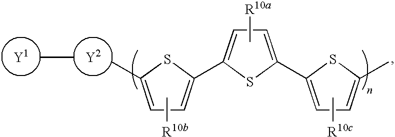
wherein Y¹ is the polymerizable residue;
wherein Y² is a linking group that is either present or absent;
wherein n is an integer selected from 1, 2, 3, 4, and 5; and
wherein each R^{10a}, R^{10b}, and R^{10c} independently comprises two substituents selected from hydrogen, cyano, halogen, thiol, hydroxyl, and optionally substituted alkyl.

11. The compound of claim 1, wherein the at least one semiconductor comprises an optionally substituted 2,3-di(pyridin-2-yl)quinoxaline residue.

12. The compound of claim 1, wherein the at least one semiconductor comprises 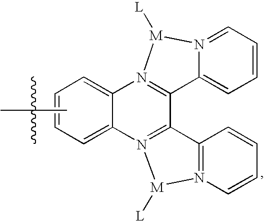
wherein M is a transition metal; and
wherein L is at least one ligand comprising an organic residue comprising one or more carbons; or
a salt thereof.

13. The compound of claim 1, wherein the polymerizable residue comprises optionally substituted alkyl, optionally substituted alkenyl, optionally substituted alkynyl, or combinations thereof.

14. The compound of claim 1, wherein the polymerizable residue comprises optionally substituted amide, optionally substituted ester, optionally substituted urethane, optionally substituted siloxane, optionally substituted phenol, optionally substituted urea, optionally substituted sulfide, optionally substituted acetal, optionally substituted ethylene, optionally substituted isobutylene, optionally substituted vinyl chloride, optionally substituted styrene, optionally substituted methyl methacrylate, optionally substituted vinyl acetate, optionally substituted vinylidene chloride, or optionally substituted isoprene.

15. A polymer of the compound of claim 1.

16. A polymer comprising at least one semiconductor and/or a photon absorber covalently bound to one or more side-chains thereof.

17. The polymer of claim 16, comprising the compound or a residue thereof of claim 1 and a photon absorber.

18. The polymer of claim 17, comprising a structure represented by a formula: 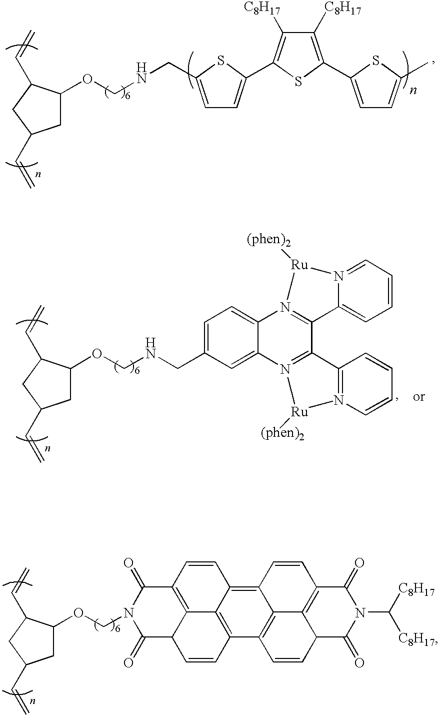
wherein n is an integer from 1 to 100,000; or
a copolymer thereof.

19. A device comprising the compound of claim 1 and/or the polymer of claim 16.

20. The device of claim 19, further comprising a photovoltaic cell.
